(19) United States
(12) Patent Application Publication
(10) Pub. No.: US 2006/0100557 A1
(43) Pub. Date: May 11, 2006

(54) Sole massager

(76) Inventor: Ming-Hsiung Huang, Taichung County (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/982,666

(22) Filed: Nov. 5, 2004

(51) Int. Cl. A61H 1/00

(52) U.S. Cl. 601/28; 601/32; 601/27; 601/23

(57) ABSTRACT

A sole massager includes a base having a pivot seat upwardly extending therefrom and a universal joint universally mounted to the pivot seat of the base. A treadle is securely connected to the universal joint opposite to the base and has an opening defined in the treadle. A cylinder transversely and rotatably mounted in the opening in the treadle and has multiple knobs extending from an outer periphery of the cylinder for massaging user's sole.

### BACKGROUND OF THE INVENTION

1. Field of the Invention

The present invention relates to a sole massager, and more particularly to a sole massager that massages user's sole and stretches user's foot tendons.

2. Description of Related Art

Modern more and more attach importance to his/her health such that many tools are used for removing tiredness after work. There are many points in the sole where acupuncture can be applied. Consequently, to suitably massage sole can has a good influence to human's health.

Conventional sole massager usually has a single function of massage. Consequently, the conventional sole massager needs to be advantageously altered.

The present invention has arisen to mitigate and/or obviate the disadvantages of the conventional sole massager.

### SUMMARY OF THE INVENTION

The main objective of the present invention is to provide an improved sole massager that massages user's sole and capable of stretching user's foot tendons.

To achieve the objective, the sole massager in accordance with the present invention comprises a base having a pivot seat upwardly extending therefrom and a universal joint universally mounted to the pivot seat of the base. A treadle is securely connected to the universal joint opposite to the base and has an opening defined in the treadle. A cylinder transversely and rotatably mounted in the opening in the treadle and has multiple knobs extending from an outer periphery of the cylinder for massaging user's sole. In addition, the user can use the universal joint to swing the treadle relative to the base for stretching his/her foot tendons.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a sole massager in accordance with the present invention;

FIG. 2 is an exploded perspective view of the sole massager in FIG. 1;

FIG. 3 is a first perspective operational view of the sole massager of the present invention; and

FIG. 4 is a side operational view of the sole massager of the present invention.

### DETAILED DESCRIPTION OF THE INVENTION

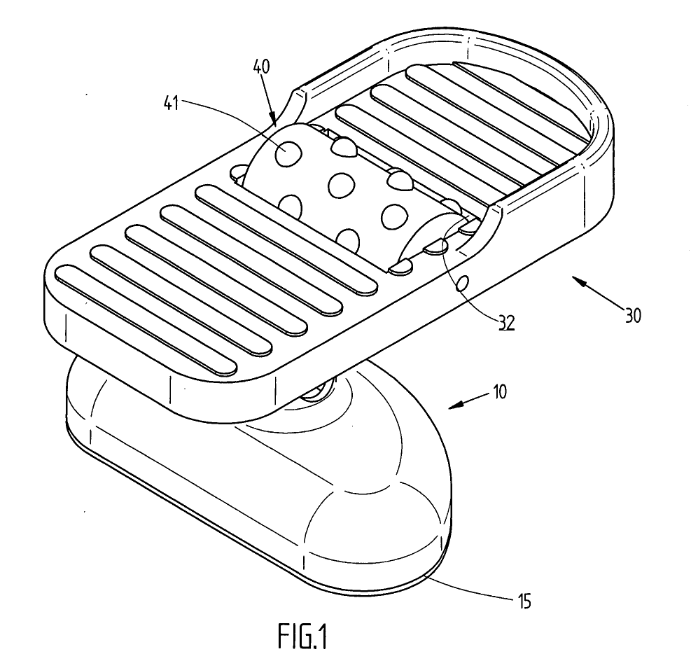

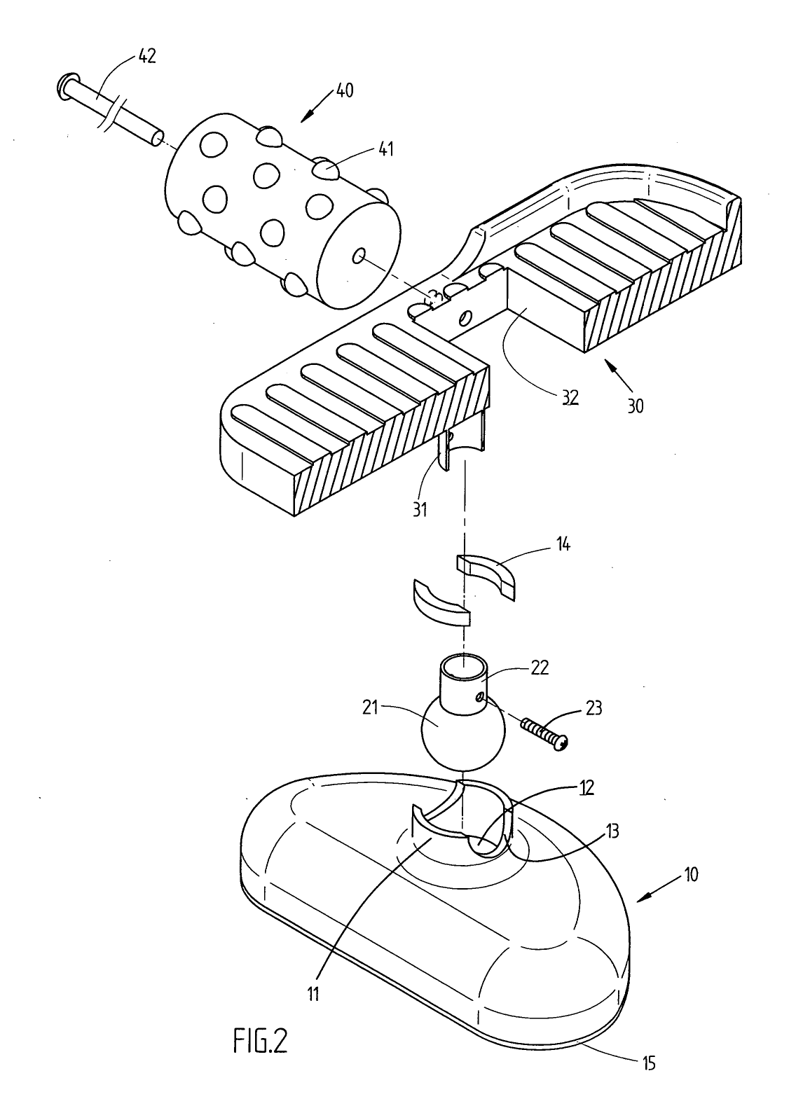

Referring to the drawings and initially to FIGS. 1 and 2, a sole massager in accordance with the present invention comprises base (10), a treadle (30) universally mounted a top of the base (10) and a cylinder (40) transversely rotatably mounted in a middle portion of the treadle (30).

The base (10) includes a pivot seat (11) upwardly extending from the top thereof and a socket (12) defined in the pivot seat (11). The pivot seat (11) has two concaves (13) defined therein. The two concaves (13) diametrically correspond to each other and respectively laterally communicate with the socket (12). An anti-slip pad (15) is securely attached to a bottom of the base (10) for positioning the base (10) during being operated.

A universal joint (20) is mounted between the base (10) and the treadle (30) for universally connecting the base (10) and the treadle (30). The universal joint (20) includes a spheroid (21) universally received in the socket (12) and a protrusion (22) upwardly extending from the spheroid (21). The base (10) further includes a pair of fasteners (14) mounted to a top of the pivot seat (11) to prevent the spheroid (21) from detaching from the socket (12).

The treadle (30) includes a connector (31) downward extending from a bottom thereof for receiving the protrusion (22). A bolt (23) is laterally screwed into the connector (31) and the protrusion (22) for securely connecting the treadle (30) and the universal joint (20). An opening (32) is defined in the middle portion of the treadle (30) for rotatably receiving the cylinder (40).

The cylinder (40) is transversely received in the opening (32). An axle (42) laterally extends through the treadle (30) and centrally extends through the cylinder (40) for positioning the cylinder (40) within the opening (32) in the treadle (30). The cylinder (40) has a diameter greater than a thickness of the treadle (30) such that the outer periphery of the cylinder (40) is located over the top of the treadle (30). The cylinder (40) includes multiple knobs (41) extend from the outer periphery of the cylinder (40) for massaging the user's sole when the cylinder (40) is rotated.

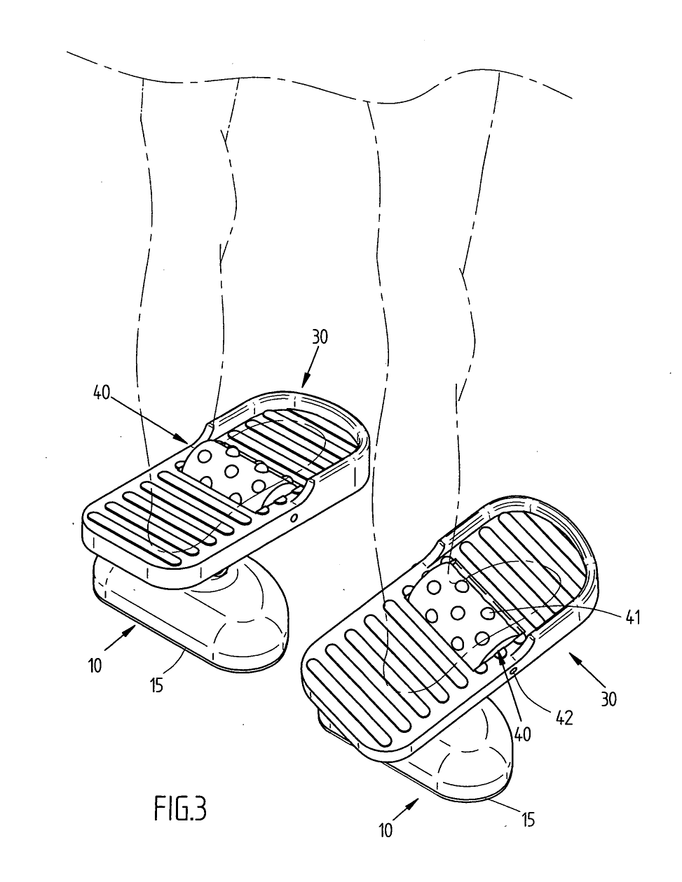

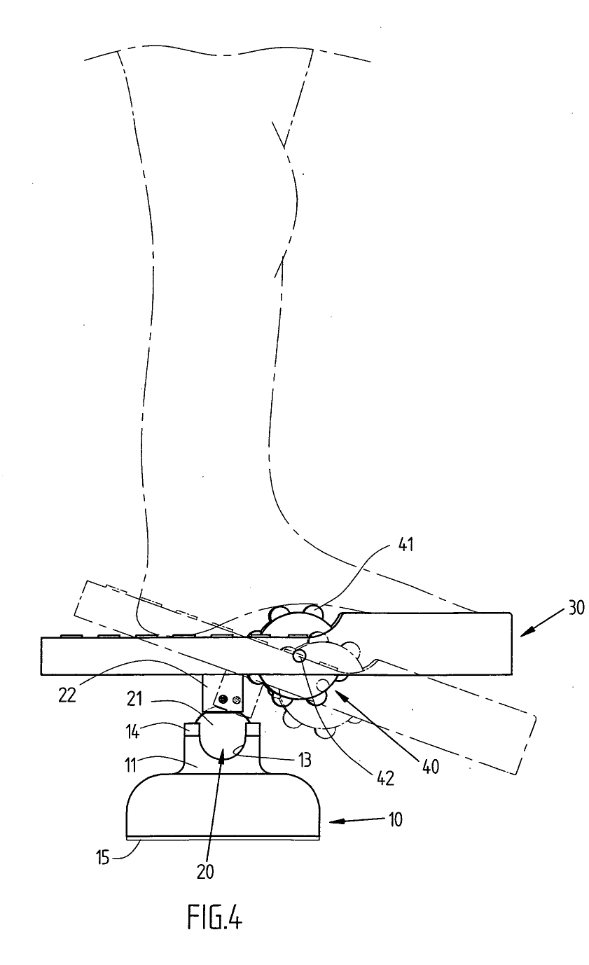

With reference to FIGS. 3 and 4, the user steps on the sole massager of the present invention and slides his/her sole to drive the cylinder (40). As a result, the knobs (41) of the cylinder (40) massage the user's sole when being rotated. Furthermore, the user can use the universal joint (20) to swing the treadle (30) relative to the base (10) for stretching his/her foot tendons. As described above, the sole massager in accordance with the present invention is a multi-functional massager for user's sole.

Although the invention has been explained in relation to its preferred embodiment, it is to be understood that many other possible modifications and variations can be made without departing from the spirit and scope of the invention as hereinafter claimed.

What is claimed is:

1. A sole massager comprising:
a base having a pivot seat upwardly extending therefrom;
a universal joint universally mounted to the pivot seat of the base;
a treadle securely connected to the universal joint opposite to the base and having an opening defined in the treadle; and
a cylinder transversely and rotatably mounted in the opening in the treadle for massaging user's sole.

2. The sole massager as claimed in claim 1, wherein the base comprises a socket defined in the pivot seat and the universal comprises a spheroid universally received in the socket.

3. The sole massager as claimed in claim 2, wherein the pivot seat comprises two concaves defined therein, the two concaves diametrically corresponding to each other and respectively laterally communicating with the socket.

4. The sole massager as claimed in claim 3, wherein the base further comprises two fasteners mounted to a top of the pivot seat to prevent the universal joint from detaching from the base.

5. The sole massager as claimed in claim 1, wherein the base comprises an anti-slip pad secured attached to a bottom of the base for positioning the base during being operated.

6. The sole massager as claimed in claim 2, wherein the universal joint comprises a protrusion upwardly extending from the spheroid and the treadle comprises a connector downward extending from a bottom of the treadle for receiving the protrusion, a bolt screwed through the connector of the treadle and the protrusion of the universal joint for securely connecting the universal joint and the treadle.

7. The sole massager as claimed in claim 1, wherein the opening is defined in a middle portion of the treadle.

8. The sole massager as claimed in claim 1, wherein the cylinder comprises multiple knobs extending from an outer periphery of the cylinder for massaging the user's sole.

9. The sole massager as claimed in claim 1 further comprising an axle laterally extending through the treadle and the cylinder to pivotally mount the cylinder within the opening in the treadle.
